(19) United States
(12) Patent Application Publication
(10) Pub. No.: US 2013/0205770 A1
(43) Pub. Date: Aug. 15, 2013

(54) METHODS OF PRIMING THERMALLY ACTIVATED ACTIVE MATERIAL ELEMENTS

(71) Applicant: GM GLOBAL TECHNOLOGY OPERATIONS LLC, (US)

(72) Inventors: Alan L. Browne, Grosse Pointe, MI (US); Nilesh D. Mankame, Ann Arbor, MI (US); Nancy L. Johnson, Northville, MI (US); Xiujie Gao, Troy, MI (US)

(73) Assignee: GM GLOBAL TECHNOLOGY OPERATIONS LLC, Detroit, MI (US)

(21) Appl. No.: 13/835,931

(22) Filed: Mar. 15, 2013

Related U.S. Application Data
(63) Continuation-in-part of application No. 12/860,937, filed on Aug. 23, 2010.

(51) Int. Cl. F03G 7/06

(52) U.S. Cl. CPC F03G 7/065
USPC 60/527

(57) ABSTRACT

A method of achieving a target activation parameter, such as a predetermined response time and/or consistency when thermally activating at least one active material element, such as a shape memory alloy actuator or shape memory polymer hinge, includes deciding whether to prime the element based on energy efficiency and/or overall system costs/performance.

### CROSS-REFERENCE TO RELATED APPLICATION

This application is a continuation-in-part of co-pending U.S. patent application Ser. No. 12/860,937, entitled “METHOD OF IMPROVING PERFORMANCE OF SMA ACTUATOR,” filed on Aug. 23, 2010, the entire contents of which is incorporated herein by reference.

### TECHNICAL FIELD

The present disclosure generally relates to systems for and methods of improving the performance and/or efficiency of active material activation under varying conditions. More specifically, the present disclosure concerns a method of achieving a target activation parameter, including deciding whether to prime the element based on energy efficiency and/or overall system costs/performance.

### BACKGROUND

Thermally activated active materials, such as shape memory alloy (SMA) materials and shape memory polymer (SMP) materials have been used to effect desirable mechanical/structural change or produce work output. For example, shape memory alloys undergo a temperature-dependent phase transformation between an austenitic and a martensitic structure, which causes a change in material properties, notably the modulus of elasticity and/or shape recovery. If the SMA is subject to external loads, this transformational behavior can be used to create a thermo-mechanical actuator. An activation signal (e.g., electric current where Joule heated, thermal heat radiation where passively activated, etc.) increases the temperature of the SMA, and thereby controls the phase transformation and contraction of the actuator. In another example, SMP elements, such as hinges, motion blockers, attachment devices, etc. are likewise activated and used across various applications to effect a change in modulus that may be further used to selectively facilitate or retain a modification, in addition to offering shape memory functionality.

### SUMMARY

Examples of the present disclosure include a method of activating at least one thermally activated active material element based on energy efficiency and/or overall system costs/performance, wherein the at least one element is communicatively coupled to an activation source, and the element and source compose a system. The method includes determining a target activation parameter for thermally activating the at least one element; determining a first value of at least one system characteristic when not initially priming the at least one element; determining a second value of the at least one system characteristic when initially priming the at least one element; comparing the first and second values, so as to determine a preferred value based on energy efficiency and/or overall system costs/performance; deciding whether to prime the at least one element based on the preferred value; and activating the at least one element after deciding whether to prime.

### BRIEF DESCRIPTION OF THE DRAWINGS

Features and advantages of examples of the present disclosure will become apparent by reference to the following detailed description and drawings, in which like reference numerals correspond to similar, though perhaps not identical, components. For the sake of brevity, reference numerals or features having a previously described function may or may not be described in connection with other drawings in which they appear.

FIG. 1 presents dual line graphs of wire diameter versus actuation energy and heating current respectively, wherein response time (t_{ON}) is constant, ambient temperature (T_{amb}) is 20° C., and priming and non-priming actuation is compared for Dynalloy Flexinol™ SMA wire samples, in accordance with an exemplary sampling; and

FIG. 2 is a perspective view of a vehicular system including thermally activated active material actuators and hinges/fold lines communicatively coupled to the vehicle charging system, and a controller intermediately coupled therebetween, in accordance with a preferred example of the present disclosure.

### DETAILED DESCRIPTION

Examples of the present disclosure include activation methods to improve performance and consistency. For example, methods have been implemented that initially prime the active material element(s), so as to reduce or provide more consistent response times, and reduce system mass, cost, and/or packaging volume, among other things. Some advantages of these methods include, for a subsequent actuation cycle, a reduction of time to heat the un-actuated element from the ambient conditions (whereas priming achieves a temperature above ambient) to the (potentially unknown) reverse phase transformation temperature, or cool the activated element to the (potentially unknown) forward phase transformation temperature. Thus, both forward and reverse transformation actuations can take place from a primed state resulting in performance that is nearly invariable even if heat transfer, loading, or physical variations are present.

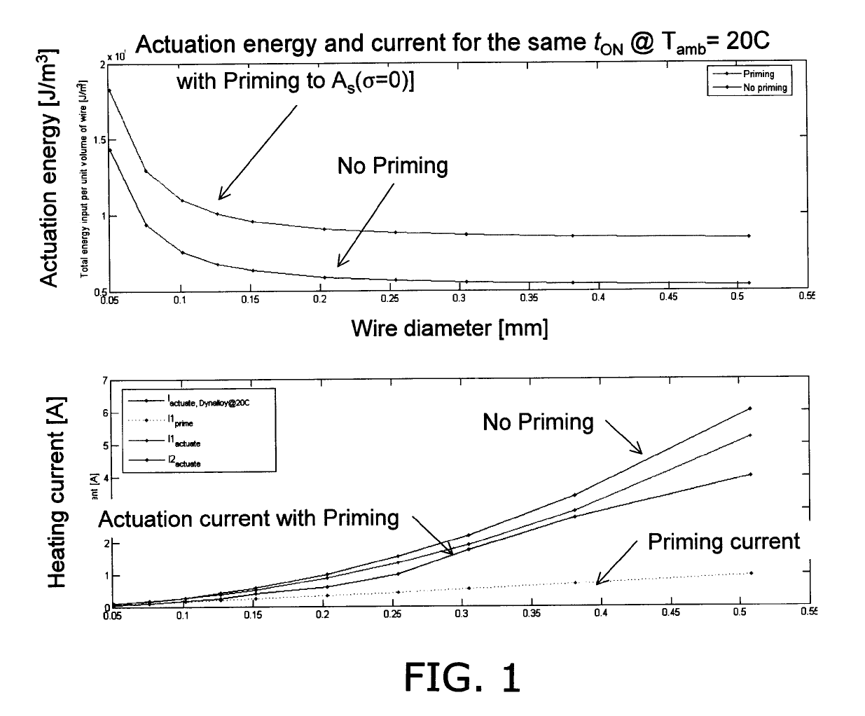

In contrast to the methods of examples of the present disclosure, systems and methodologies such as these were used in prior systems wherever priming was available regardless of system characteristics—this may result in inefficiencies and/or reduced system performance. For example, and as shown in FIG. 1, it is appreciated that employing a prime signal prior to the reduced activation signal when Joule heating SMA, requires greater actuation energy but lower heating current than applying a normal activation signal without priming. That is to say, priming is not energy efficient when the desired actuation power is within the range of the power source.

Examples of the present disclosure provide a method of controlling the activation of at least one thermally activated active material element, such as a shape memory alloy actuator or shape memory polymer hinges, motion blockers, attachment devices, etc., which includes deciding whether to prime the element based on energy efficiency and/or overall system costs/performance. That is to say, the priming decision may be made at the system design stage based on overall system fixed and operational costs, and/or at the system usage stage based on energy efficiency for a given set of conditions. The method reduces the energy associated with and the controller cost and complexity for priming active material element(s), where an activation target has been predetermined. Examples of the present disclosure may therefore be useful for better meeting user expectations in terms of device responsiveness and consistency of performance irrespective of ambient conditions, and determining the best way to utilize available resources in doing so.

Generally, examples of the present disclosure include an improved method of activating at least one thermally activated active material element based on energy efficiency and/or overall system costs/performance, wherein each element is communicatively coupled to an activation source, such that the element and source compose a system. An example of the method includes the initial step of determining a target activation parameter for thermally activating the at least one element. Next, first and second values of a system characteristic are determined when priming and not priming the element, respectively. The first and second values are compared, so as to determine a preferred value based on energy efficiency and/or overall system costs/performance. Whether to prime the at least one element is then decided based on the preferred value; and the at least one element is activated only after deciding whether to prime.

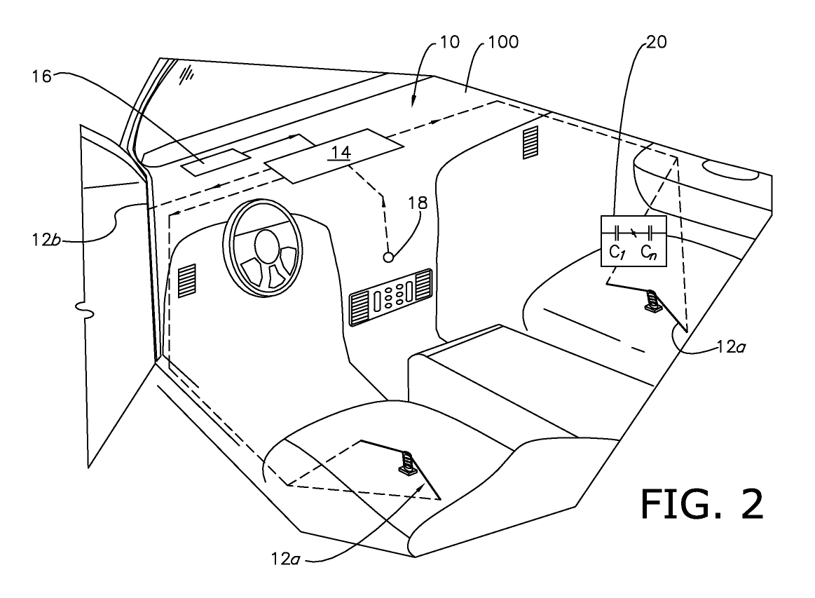

Examples of the present disclosure provides a method of, and system 10 for improving the activation of at least one thermally activated active material element 12, such as a shape memory alloy actuator 12a or shape memory polymer hinge, fold line, motion blocker, attachment mechanism, latch, etc. 12b (FIG. 2). More particularly, the present disclosure concerns a control algorithm for achieving a targeted activation parameter in a more energy or cost effective manner. The inventive algorithm decides whether to prime the element 12 based on system design stage and/or system usage considerations as opposed to for example, SMA timing alone. The method may be employed singularly when an existing element 12 is initially brought on-line (i.e., an existing system 10 is retrofitted) or on an application-by-application basis by assessing system components prior to an activation event. The present disclosure is applicable wherever thermal activation of active materials is contemplated, and is particularly suited for benefiting the design and operation of a vehicle 100. Using the inventive method, efficient activation within a targeted response time and/or consistency can be achieved under varying ambient and operating conditions by first determining, at the design stage, whether priming or temporary energy storage may become necessary, whether priming is more cost effective and/or energy efficient in comparison to energy storage equivalents, and then whether priming is necessary for a given set of conditions at the usage stage. The examples, configurations, and implementations depicted and described herein are meant to illustrate and support rather than limit the present disclosure, unless expressly incorporated into the claims. For example, although the present disclosure is more generally concerned with “on-off” actuation, a number of its aspects can be applied to position control applications as well.

As used herein the term “active material” is defined as any material or composite that exhibits a reversible change in fundamental (i.e., chemical or intrinsic physical) property when exposed to or precluded from an activation signal; and as previously mentioned, the present disclosure pertains to thermally activated active materials, such as shape memory alloys, shape memory polymers, and paraffin wax.

Shape memory alloys (SMAs) generally refer to a group of metallic materials that demonstrate the ability to return to some previously defined shape or size when subjected to an appropriate thermal stimulus. Shape memory alloys are capable of undergoing phase transitions in which their yield strength, stiffness, dimension and/or shape are altered as a function of temperature. Generally, in the low temperature, or Martensite phase, shape memory alloys can be pseudo-plastically deformed and upon exposure to some higher temperature will transform to an Austenite phase, or parent phase, and return, if not under stress, to their shape prior to the deformation.

Shape memory alloys exist in several different temperature-dependent phases. The most commonly utilized of these phases are Martensite and Austenite phases. In the following discussion, the Martensite phase generally refers to the more deformable, lower temperature phase whereas the Austenite phase generally refers to the more rigid, higher temperature phase. When the shape memory alloy is in the Martensite phase and is heated, it begins to change into the Austenite phase. The temperature at which this phenomenon starts is often referred to as Austenite start temperature (Aₛ). The temperature at which this phenomenon is complete is called the Austenite finish temperature (A_{f}).

When the shape memory alloy is in the Austenite phase and is cooled, it begins to change into the Martensite phase, and the temperature at which this phenomenon starts is referred to as the Martensite start temperature (Mₛ). The temperature at which Austenite finishes transforming to Martensite is called the Martensite finish temperature (M_{f}). Thus, a suitable activation signal for use with shape memory alloys is an electric current having an amperage sufficient to cause transformations between the Martensite and Austenite phases.

The temperature at which the shape memory alloy remembers its high temperature form when heated can be adjusted by slight changes in the composition of the alloy, through heat treatment, and by exposing the alloy to stress. In nickel-titanium shape memory alloys, for instance, it can be changed from above about 100° C. to below about −100° C. The shape recovery process occurs over a range of just a few degrees and the start or finish of the transformation can be controlled to within a degree or two depending on the desired application and alloy composition. The mechanical properties of the shape memory alloy vary greatly over the temperature range spanning their transformation, typically providing the system with shape memory effects, superelastic effects, and high damping capacity.

Suitable shape memory alloy materials include, without limitation, nickel-titanium based alloys, indium-titanium based alloys, nickel-aluminum based alloys, nickel-gallium based alloys, copper based alloys (e.g., copper-zinc alloys, copper-aluminum alloys, copper-gold, and copper-tin alloys), gold-cadmium based alloys, silver-cadmium based alloys, indium-cadmium based alloys, manganese-copper based alloys, iron-platinum based alloys, iron-platinum based alloys, iron-palladium based alloys, and the like. The alloys can be binary, ternary, or any higher order so long as the alloy composition exhibits a shape memory effect, e.g., change in shape orientation, damping capacity, and the like.

Shape memory polymers (SMP's) generally refer to a group of polymeric materials that demonstrate the ability to return to a previously defined shape when subjected to an appropriate thermal stimulus. Thermally-activated shape memory polymers are polymers that have elastic moduli that change substantially (usually by one to three orders of magnitude) across a narrow transition temperature range, e.g., 0° C. to 150° C., depending upon the composition of the polymer, and which exhibit a finite rubbery plateau in their elastic response at temperatures above the transition range where the modulus remains fairly constant.

Suitable polymer components to form a shape memory polymer include, but are not limited to, polyphosphazenes, poly(vinyl alcohols), polyamides, polyester amides, poly(amino acid)s, polyanhydrides, polycarbonates, polyacrylates, polyalkylenes, polyacrylamides, polyalkylene glycols, polyalkylene oxides, polyalkylene terephthalates, polyortho esters, polyvinyl ethers, polyvinyl esters, polyvinyl halides, polyesters, polylactides, polyglycolides, polysiloxanes, polyurethanes, polyethers, polyether amides, polyether esters, and copolymers thereof. Examples of suitable polyacrylates include poly(methyl methacrylate), poly(ethyl methacrylate), ply(butyl methacrylate), poly(isobutyl methacrylate), poly(hexyl methacrylate), poly(isodecyl methacrylate), poly(lauryl methacrylate), poly(phenyl methacrylate), poly(methyl acrylate), poly(isopropyl acrylate), poly(isobutyl acrylate) and poly(octadecyl acrylate). Examples of other suitable polymers include polystyrene, polypropylene, polyvinyl phenol, polyvinylpyrrolidone, chlorinated polybutylene, poly(octadecyl vinyl ether) ethylene vinyl acetate, polyethylene, poly(ethylene oxide)-poly(ethylene terephthalate), polyethylene/nylon (graft copolymer), polycaprolactones-polyamide (block copolymer), poly(caprolactone) dimethacrylate-n-butyl acrylate, poly(norbornyl-polyhedral oligomeric silsequioxane), polyvinylchloride, urethane/butadiene copolymers, polyurethane block copolymers, styrene-butadiene-styrene block copolymers, and the like.

Depending on the nature of the polymer morphology a wide variety of SMPs can be formed. One way of classifying SMPs is based on the nature of the cross-links. The irreversible cross-links in thermoset SMPs are formed by covalent bonds. Thermoplastic SMPs do not have truly irreversible cross-links. They have two or more types of reversible cross-links that are formed and broken over finitely separated temperature ranges. Any of the temperature ranges across which the polymer behaves in the manner specified above can be treated as a transition range for the material. Typically, the lowest temperature range that falls within the range of normal operating conditions for the material is used as the transition range. When the material is heated above its transition range only the cross-links corresponding to this range and all lower ranges are broken. The cross-links that break and form at higher temperatures are unaffected, and play the role of irreversible cross-links.

Returning to the present disclosure, the control algorithm is especially applicable in regards to the controlled activation of and thus release of stored energy within shape memory polymer elements 12, as it is appreciated that heating and cooling times in general are significantly greater with SMP than SMA. That is to say, because of the low thermal conductivity of SMP materials and thus slow response to temperature increases in the surrounding environment, priming for passively activated SMP devices can improve uniformity of response over a wide range of ambient temperature.

In FIG. 2, a vehicular example of a system 10 for implementing the method of the present disclosure is shown. A controller 14 is communicatively coupled (e.g., connected via hardwire or through suitable short range wireless communication) to SMA actuators 12a and SMP hinge, fold line, motion blocker, attachment mechanism, latch, etc. 12b. It is appreciated that other geometric forms of thermally activated active material elements 12 may be employed. In a preferred example, the controller 14 includes memory operable to store first and second values of a system characteristic (e.g., construction cost, operating cost, actuation energy, available power, etc.) corresponding to activation with and without priming respectively. The system 10 further includes and the controller 14 is coupled to an activation source 16, such as the charging system/battery of the vehicle 100. It is appreciated that the vehicle bus and other nodes (not shown) further compose the system 10 and must be accounted for. Lastly, the preferred controller 14 is communicatively coupled to a vehicle user device (e.g., key fob) or vehicle sensor (e.g., a vehicle event prediction sensor or vehicle event sensor) 18 for, e.g., providing a signal for initiating any of the steps of the method. Application specific inputs include relationships between the demand for device operation and vehicle operating parameters—such as a) priming of door latches only when the vehicle 100 is stopped and/or when the gear is shifted into park and b) priming as well as adjusting the rapidity of priming of predetermined vehicle devices based on sensor input as to both the probability of, as well as the remaining time before a potential vehicle event.

The method generally offers strategy for determining whether to prime the element 12 prior to activation, wherein priming the active material element 12 involves applying an electric signal having less strength than the approximate signal strength determined to be necessary to initiate activation. At the design stage of the system 10, the method initiates with an assessment of the activation signal source 16 to determine whether the source 16 is capable of achieving the target activation parameter for at least one active material element 12, and more preferably, for all elements 12 concurrently (i.e., maximum demand). To that end, an anticipatory set of actuation conditions are assumed, such as ambient temperature, RH, Load position, condition of the active material element(s) 12, available voltage (e.g., voltage on the vehicle power bus), state of charge of power storage devices where included, and the desired actuation power for each element 12. It is appreciated that information relating to the source 16 and conditions may be manually inputted or autonomously detected/probed and entered into the algorithm. For example, in a vehicular setting, it may be determined that the vehicle charging system 16 presents the necessary voltage to effect activation of all elements 12 within a maximum response time given the assumed set of conditions, but not the necessary consistency, due to fluctuations in demand and internal health/state of the battery or alternator.

If the source 16 is unable to meet the targeted activation parameter, the preferred method then compares construction/operating costs for the system 10 when priming the active material elements 12 versus utilizing a temporary energy storage medium, such as a capacitor bank 20; and constructs the system 10 based upon this comparison. It is appreciated that a combination of both priming and energy storage may be utilized in a cost effective manner, based on the average life or anticipated usage of the element 12. For example, priming may be provided for frequently used elements 12, while storage capacitors 20 are used for infrequently activated elements 12. In FIG. 2, a capacitor bank (C₁ . . . Cₙ) 20 is shown associated with an SMA actuator 12a drivenly coupled to the passenger seat, but not a similar actuator 12a drivenly coupled to the more frequently occupied driver seat. The method may end here to provide an initial cost-benefit analysis of whether priming should occur based on overall system construction/operating costs and performance for a given set of anticipated conditions.

Where the ability of the source 16 to meet the target may vary, however, the method continues to assess the state of the system 10 at the system usage stage. Here, the system 10 is configured to obtain input regarding at least one existing condition that affects the ability of the source 16 to meet the targeted activation parameter. For example, the system 10 may be configured to determine at least one of ambient temperature, RH, Load position, condition of the active material element(s) 12, available voltage (e.g., voltage on the vehicle power bus), and state of charge of power storage devices 20. That is to say, the inability of the source 16 to meet the target may be promulgated by a condition internal or external to the source 16. In this regard, the device/sensor 18 may be employed to detect a value of the condition, and directly compare the value to a threshold priming value, such that the condition is the system characteristic, or use look-up tables, etc. to indirectly determine the value of the system characteristic based on the sensed condition. The actuation requirements under the given conditions determine the threshold value. If the source 16 is able to achieve the target, i.e., the first value is greater than the threshold value, then a decision is made not to prime the element 12 before activation.

Otherwise, if the value is less than or equal to the threshold value, priming is performed by the source 16 as described below. In this regard, priming may be constant (i.e., always “ON”) or event triggered; and is provided to reduce the peak power demand on the electrical power source 16 to meet the same actuation time. More preferably, priming to a predetermined degree is performed based on the comparison of values; and the duration and/or amplitude of the priming signal is preferably adjustable in order to achieve the priming goals based on the comparison. Priming adjustment may be made during priming based on comparisons determined during priming. For example, in a vehicular setting, the greater the difference between ambient temperature minus threshold temperature, the more priming is necessary to raise the internal temperature of the element 12 to 25° C., whereas it is appreciated that SMA actuation can be achieved from a 25° C. starting point within the required response time and consistency necessary for vehicle applications in which a system designer may desire improved response times. Where the ambient temperature has risen but activation has still yet to occur, the preferred system 10 is operable to adjust the priming signal, so as to maintain the 25° C. starting point using open or closed-loop feedback. Once activation is completed, the priming signal is preferably discontinued, so as to facilitate cooling and deactivation. Lastly, in usage stage decisions, the controller 14 preferably nullifies the values from memory prior to a subsequent periodic or event triggered assessment.

More particularly, the present disclosure provides a method of controlling a thermally activated active material element so as to achieve a targeted activation parameter, such as a maximum response time and more consistent performance, regardless of variable heat transfer and mechanical loading conditions. Though the priming approach may be less energy efficient than providing a burst of current to the system 10 by discharging a capacitor bank 20, it may lead to a lighter, lower initial/fixed cost, and smaller overall system 10 than if a capacitor bank 20 were used for the same performance. The degree of priming is also a consideration that may contribute to the overall priming decision. That is to say, the need to prime for consistency in response time rather than minimizing response time plays a role in the determination. ‘Always ON/keep warm’ priming (i.e. when the priming current is left on even when the actuation current is off) is suitable for meeting response time consistency and keeping control logic to a minimum. In this case, priming to a reference ambient temperature, e.g., 25° C., is reasonable. This ensures that the system 10 may be designed for operation at a minimum ambient temperature and the priming will ensure that the response time is consistently within a predetermined limit.

Where minimizing response time is the primary goal, the preferred system 10 is configured to prime the element(s) 12 to Aₛ (σ=0)−Δ, wherein Δ is an error margin that provides control robustness, and σ is the stress acting upon the element 12. Where the load is fixed (corresponding to σ), priming can be adjusted to Aₛ (σ)−Δ. For example, the margin, Δ, may be set between the temperature at which phase change will initiate and the lower temperature to which one can prime while maintaining control robustness. In these cases, however, the priming current must be discontinued after actuation occurs until the temperature of the element 12 has cooled to a temperature Δ less than M_{f} so that the priming current does not hinder cooling. Additionally, it is appreciated that priming close to Aₛ places requirements for greater accuracy and responsiveness on the controller 14 because of the increased likelihood of inadvertent actuation. Priming close to Aₛ is desirable in applications related to vehicle events where a rapid response reduces the burden on vehicle event prediction sensing systems. Priming to a relatively lower temperature may reduce energy consumption, provide control simplicity and maintain control robustness, and as such should be considered for applications not needing a rapid response.

With regard to priming, exemplary techniques for bringing the thermally activated active material element 12 to a state in which it is close to transition (either forward in the case of cooling or reverse in the case of heating) include open-loop priming control. That is to say, the necessary priming signal strength may be determined through active periodic probing, or by taking independent measurements or estimates of ambient temperature, stress, and other associated variables, or by using a calibration table (e.g., a “look-up table”). The benefit of open-loop control is reduced complexity, reduced computation time and program space which in turn reduces the controller cost, and the avoidance of excessive overshoot that may result during close-loop control. For example, the method may be implemented using an open-loop controller 14 in which the applied signal strength is either offset or scaled from a pre-determined value (current, or PWM duty cycle). Alternatively, open loop priming can be accomplished using some proportion, e.g., 50%, of the required activation signal found via probing, calculation, etc.

Alternatively, priming control may be closed-loop. With respect to SMA, the controller 14 may consider the resistance of the actuator 12a or derivative(s) thereof as feedback, as it is appreciated that resistance is directly correlated to the transformation state of SMA. In this case, absolute resistance values may be determined through active periodic probing. For example, the method may be implemented using a ramp (current or PWM duty cycle) based on a predetermined value, and then switching to a closed-loop controller which i) uses a predetermined value of resistance at the cusp of transformation as input to a feedback controller, ii) uses dR/dt as input to a feedback controller, or iii) uses peak/minimum detection and a bang-bang controller to heat/cool the system to maintain it at the resistance peak. Closed-loop priming using SMA resistance or its derivative may be accomplished by priming a small distance from the cusp of transformation. For example, the SMA may be primed to dR/dt=0.1 or higher. When actuation is called for, the SMA can be quickly heated or cooled to initiate phase (reverse or forward) transformation. Once the cusp is determined, the signal may be reduced according to appropriate reliability estimates.

In another implementation, closed loop priming involves servoing around the cusp at which the theoretical value of dR/dt is zero. It is appreciated, however, that dR/dt=0 at any resistance value wherein the current is constant and not causing actuation. Therefore, it may be desirable to first ramp up the duty cycle of the PWM signal to raise the temperature of the SMA to the point at which its resistance reaches the heating cusp leading towards the reverse phase transformation, and then the servo controller can be turned on. For example, the duty cycle of the PWM signal may be ramped up at the beginning of the priming period to a maximum duty cycle equal to 0.8 times the activation signal. This avoids detection of zero gradients in the resistance curve which may exist at low duty cycles due to noise on the collected samples, and also starts peak detection at a point that is sufficiently close to the cusp. A peak detector (not shown) may then be used to detect the cusp. Conversely, if the forward transformation is to be initiated, it may be desirable to ramp down the duty cycle of the PWM signal to reduce the temperature of the SMA to the point at which its resistance reaches the cooling cusp, and then the servo controller can be turned on. A trough detector (also not shown) may then be used to detect the cusp. Any of a number of commercially available peak and trough detection algorithms can be used for this purpose, as well as the algorithm introduced above. In a very simple implementation, a cusp may be considered to have been detected when the computed resistance values continue with the same slope polarity over three consecutive samples.

In some systems, priming may be beneficial to pre-arm the system 10 (without however firing/actuating) in a short period of time in order to allow either a) getting the subsequent deploy (if there is a need to deploy) within the required activation delta time or b) to reduce the power demand for activation. In either case because of the short period of priming the system 10 may be assumed to be essentially adiabatic. For other vehicle systems 10 in which there is a large delta time for priming, a heat transfer model may be employed to determine the priming magnitude and frequency again based on ambient temperature and time since last activation or priming event. The operative idea for all vehicle systems 10 is to minimize the input energy required for priming. It is appreciated that priming in the other vehicle systems 10 may be used to reduce the delta time required for activation to a) provide consistent response independent of environmental conditions or system state, b) meet user expectations, c) meet/adjust to user preferences, or d) satisfy event or operational requirements, for example to switch a grab handle from a slow smooth response desired for ingress/egress assist to a rapid deploy under hard cornering. Other aspects of a), b) and c) include smoothing out response over a broad ambient temperature range or over a broad range of pre-stress in the wire (i.e. to avoid sudden jettisons or prolonged delays where the user expects a slow smooth deploy of a grab handle).

As used herein, the terms “first”, “second”, and the like do not denote any order or importance, but rather are used to distinguish one element from another.

In describing and claiming the examples disclosed herein, the singular forms “a”, “an”, and “the” include plural referents unless the context clearly dictates otherwise.

Furthermore, reference throughout the specification to “one example”, “another example”, “an example”, and so forth, means that a particular element (e.g., feature, structure, and/or characteristic) described in connection with the example is included in at least one example described herein, and may or may not be present in other examples. In addition, it is to be understood that the described elements for any example may be combined in any suitable manner in the various examples unless the context clearly dictates otherwise.

It is to be understood that the ranges provided herein include the stated range and any value or sub-range within the stated range. For example, a range from 0° C. to 150° C. should be interpreted to include not only the explicitly recited limits of 0° C. to 150° C., but also to include individual values, such as 25° C., 67.5° C., etc., and sub-ranges, such as from about 50° C. to about 111° C., etc. Furthermore, when “about” is utilized to describe a value, this is meant to encompass minor variations (up to +/−10%) from the stated value.

While several examples have been described in detail, it will be apparent to those skilled in the art that the disclosed examples may be modified. Therefore, the foregoing description is to be considered non-limiting.

1. A method of activating at least one thermally activated active material element based on energy efficiency and/or overall system costs/performance, wherein the at least one element is communicatively coupled to an activation source and the element and source compose a system, the method comprising the steps of:
a) determining a target activation parameter for thermally activating the at least one element;
b) determining a first value of at least one system characteristic when not initially priming the at least one element;
c) determining a second value of the at least one system characteristic when initially priming the at least one element;
d) comparing the first and second values, so as to determine a preferred value based on energy efficiency and/or overall system costs/performance;
e) deciding whether to prime the at least one element based on the preferred value; and
f) activating the at least one element after deciding whether to prime.

2. The method as defined in claim 1, wherein the at least one active material element includes a shape memory alloy actuator.

3. The method as defined in claim 1, wherein the at least one active material element is formed of a shape memory polymer.

4. The method as defined in claim 1, wherein the parameter is a predetermined maximum response time.

5. The method as defined in claim 4, wherein step a) further includes the steps of initially determining an error margin, so as to maintain control robustness.

6. The method as defined in claim 1, wherein the parameter is a response time consistency.

7. The method as defined in claim 1, wherein the system characteristic is the sum of the fixed costs of constructing and operating the system, the first value is greater than the second value, step e) further includes the steps of deciding to prime the at least one element, and step f) further includes the steps of priming the at least one element.

8. The method as defined in claim 1, further comprising:
g) nullifying the first and second values after activating the at least one element, and repeating steps a) through f) to reactivate the at least one element.

9. The method as defined in claim 1, further comprising:
g) storing the first and second values after activating the at least one element, and repeating steps e) and f) to reactivate the at least one element.

10. The method as defined in claim 1, wherein step e) further includes the steps of deciding to prime the at least one element; step f) further includes the steps of priming the at least one element by applying a priming signal thereto; and further comprising:
g) discontinuing the signal, so as to accelerate deactivation.

11. The method as defined in claim 1, wherein step e) further includes the steps of deciding to prime the at least one element, and further determining a degree of priming; and step f) further includes the steps of priming the at least one element based on the degree of priming.

12. The method as defined in claim 1, wherein step e) further includes the steps of employing a heat transfer model.

13. The method as defined in claim 1, wherein the characteristic is overall system construction and operating costs, step b) further includes the steps of determining the first value when employing a capacitor bank, and step c) further includes the steps of determining the second value when not employing a capacitor bank.

14. The method as defined in claim 1, wherein the system defines a design stage and a usage stage, step b) further includes the steps of determining a first value of a first system characteristic at the system design stage, and a first value of a second system characteristic at the system usage stage, step c) further includes the steps of determining a second value of the first and second system characteristics respectively, step d) further includes the steps of comparing both sets of first and second values, so as to determine first and second preferred values based on energy efficiency and overall system costs/performance, and step e) further includes the steps of deciding whether to prime the at least one element based on the first and second preferred values.

15. The method as defined in claim 1, wherein step e) further includes the steps of deciding to prime the at least one element based on the preferred value and only after determining a triggering event.

16. The method as defined in claim 15, wherein the at least one element is associated with a vehicle, and step e) further includes the steps of deciding to prime in response to a user of the vehicle and/or a vehicle sensor.

17. The method as defined in claim 1, wherein the system characteristic is the ability of the source to achieve the parameter, the first and second values are affirmative and negative, respectively, step e) further includes the steps of deciding to prime the at least one element; and step f) further includes the steps of priming the at least one element.

18. The method as defined in claim 17, wherein steps b) and c) further include the steps of initially determining at least one system condition selected from the group consisting essentially of the maximum available electrical power from the source, state of charge of power storage devices, condition of the at least one element, ambient temperature, quantity of stress acting upon the at least one element, and load position.

19. The method as defined in claim 17, wherein a plurality of elements are communicatively coupled to the activation source, and steps b) and c) further include the steps of determining for each element the ability of the system to achieve the target concurrently.

20. The method as defined in claim 19, wherein each element presents a frequency of use, the preferred values differ, and step e) further includes the steps of deciding to prime a portion of the elements according to the frequencies of use.
